(19) United States
(12) Patent Application Publication
(10) Pub. No.: US 2007/0207927 A1
(43) Pub. Date: Sep. 6, 2007

(54) Polymer based seed coating

(76) Inventors: Fred C. Rosa, Wake Forest, NC (US); William S. Hanson, Wake Forest, NC (US); Jackie S. Mote, Wylie, TX (US)

Correspondence Address: BAYER CROPSCIENCE LP, Patent Department, 2 T .W. ALEXANDER DRIVE, RESEARCH TRIANGLE PARK, NC, 27709, US

(21) Appl. No.: 11/365,123

(22) Filed: Mar. 1, 2006

(51) Int. Cl. A01N 25/10; A01N 25/26

(52) U.S. Cl. 504/100; 504/361

(57) ABSTRACT

A seed coating to facilitate the binding of an bioactive ingredient, such as an insecticide or fungicide, to seed and allowing for the flowability of the coated seed during planting comprising a binder, a wax, a pigment, and one or more stabilizers in an amount effective to stabilize the suspension. A process for coating the seeds and the product of the process are also disclosed.

### BACKGROUND OF THE INVENTION

This invention relates to a seed coating to facilitate the binding of an bioactive ingredient, such as an insecticide or fungicide, to seed and allowing for the flowability of the coated seed during planting.

The control of insects and related arthropods is of extreme importance to the agricultural industry. Every year, these pests destroy an estimated 15% of agricultural crops in the United States and even more than that in developing countries. Some of this damage occurs in the soil when plant pathogens, insects and other such soil borne pests attack the seed after planting. Much of the rest of the damage is caused by rootworms; plant pathogens that feed upon or otherwise damage the plant roots; and by cutworms, European corn borers, and other pests that feed upon or damage the above ground parts of the plant. General descriptions of the type and mechanisms of attack of pests on agricultural crops are provided by, for example, Metcalf, in Destructive and Useful Insects, (1962); and Agrios, in Plant Pathology, 3rd Ed., Academic Press (1988).

The period during germination of the seed, sprouting and initial growth of the plant is particularly critical because the roots and shoots of the growing plant are small and even a small amount of damage can kill the entire plant. Moreover, some natural plant defenses are not fully developed at this stage and the plant is vulnerable to attack. Not surprisingly, the control of pests that attack the seed and the above ground plant parts during this early stage of plant growth is a well developed area of agriculture.

Currently, the control of pests that attack post emergent crops primarily involves the application of synthetic organic pesticides to the soil, or to the growing plants by foliar spraying. Because of concern about the impact of chemical pesticides on public health and the environment, there has been much effort to reduce the amount of chemical pesticides that are used.

Insecticides such as imidacloprid and clothianidin; and the like, are very effective against certain above ground plant pests when applied at the proper time and with proper procedures. Appropriate pesticides may be applied at the time of planting as surface bands, “T”-bands, or in-furrow, but these applications require the additional operation of applying the pesticide at the same time as the seeds are being sown. This complicates the planting operation and the additional equipment required for pesticide application is costly to purchase and requires maintenance and attention during use. Moreover, care must be taken to incorporate the pesticides properly into the topmost soil layer for optimal activity.

The control of pests by applying insecticides directly to plant seed is well known. For example, U.S. Pat. No. 5,696,144 discloses that the European corn borer caused less feeding damage to corn plants grown from seed treated with a 1-arylpyrazole compound at a rate of 500 g per quintal of seed than control plants grown from untreated seed. In addition, U.S. Pat. No. 5,876,739 to Turnblad et al. (and its parent, U.S. Pat. No. 5,849,320) disclose a method for controlling soil-borne insects which involves treating seeds with a coating containing one or more polymeric binders and an insecticide. This reference provides a list of insecticides that it identifies as candidates for use in this coating and also names a number of potential target insects. However, while the U.S. Pat. No. 5,876,739 patent states that treating corn seed with a coating containing a particular insecticide protects corn roots from damage by the corn rootworm, it does not indicate or otherwise suggest that the coating while helping to bind the insecticide to the seed also provides an ease in dispersion of the seed in order to help maximize the economic potential for the farmer.

The use of talc as a lubricating agent is well known in the seed industry. See for example Agronomy Bulletin by Agrilance (Apr. 9, 2004) where various insecticides are offered with a talc-based formulation. Graphite is an alternative lubricant but many times it is prohibited for use in certain planting equipment.

Seeds treated with insecticide can cause plant-spacing problems because the seeds coated just with the insecticide can have a pebbly, rough surface compared to smooth, untreated kernels. Most planters are designed to handle smooth surface seed. Adding talc for vacuum planters or graphite for seed planted through finger pickup planters has been one solution.

### SUMMARY OF THE INVENTION

Farmers need to maximize their yield and if seeds are not lubricated properly then not enough seeds are planted per acre. Typical in the industry a goal of approximately 30,000 seeds per acre is considered ideal. Seeds that have been coated with one or more bioactive ingredients such as an insecticide, fungicide, or a safener can be lubricated to achieve this potential planting goal.

### DETAILED DESCRIPTION OF THE INVENTION

Seeds can be batch or continuous feed treated with a polymer coating to facilitate plantability. The polymer coating is comprised of a binder, a wax and a pigment, and one or more stabilizers in an amount effective to stabilize the suspension.

The binder can be a polymer selected from the group consisting of vinyl acetate-ethylene copolymer, vinyl acetate homopolymer, vinyl acetate-acrylic copolymer, vinylacrylic, acrylic, ethylene-vinyl chloride, vinyl ether maleic anhydride, or butadiene styrene. Other similar polymers can be used.

The wax can be natural wax (beeswax or lanolin), vegetable wax (Carnauba), mineral wax (montan or paraffin), synthetic wax (polyethylene (polar or nonpolar), polypropylene, Fischer-Tropsch, or polybutene), or another lubricant such as polytetrafluoroethylene. There are many other waxes that can be used.

The stabilizers can be one or more of the following type of ingredients: a suspending aid, a humectant and a biocide. The suspending aid can be attapulgite clay, bentonite clay, smectite clay, hectorite clay, cellulosic, xanthum gum, or guar gum.

A humectant can be included as a stabilizer to promote the retention of water, an element that can be crucial to the viability of the seed. A typical humectant that is commonly used is propylene glycol. Many other humectants will work.

Another stabilizer that can be added is a biocide. A common biocide found in the market is 1,2-benzisothiazolin-3-one, which can be obtained from Avecia, Inc. as Proxel GXL as a solution in sodium hydroxide and dipropylene glycol.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. As one skilled in the art can appreciate, the exact amount of coating will vary depending on the size of the seed to be coated. Unless otherwise noted, all temperatures are degrees Celsius and all parts and percentages are parts by weight and percentages by weight, respectively.

The amount of wax in the coating will be in the range of about 12.5% to 30% of the total weight of the binder, preferably at 15%. The wax of the preferred embodiment is a polyolefin based micronized wax powder, known in the art as MICHEM® Wax 437 (obtained from Michelman). The pigment will be in the range of 0 to 15% of the weight of the binder and in the preferred embodiment is a titanium dioxide coated mica (Luster White FR2P from Stochem) at 15% of the total weight of the binder. The amount of polyolefin polymer will typically be 20% by weight of the binder and preferably will be a carboxylated styrene-butadiene dispersion (Styrofan® NX 6650 X from BASF at 20% of the total weight of the binder).

One or more stabilizers can be added to the coating. A suspending aid can be added in the range of 0.50% to 1.00% of the weight of the binder. In the preferred embodiment, the suspending aid was Van Gel B (obtained from R. T. Vanderbilt Company, Inc. as a 5% solution) at 1.0% of the total weight of the binder. The humectant can vary from 2.4% to 4.9% of the total weight of the binder and in the preferred embodiment the humectant was propylene glycol at 4.9% of the total weight of the binder. A biocide can be added in the range of 0.10% to 0.20% of the total weight of the binder and in the preferred embodiment was Proxel GXL at 0.20% (obtained from Avecia, Inc. as a solution in sodium hydroxide and dipropylene glycol). The binder is prepared in a water solution, and in the preferred embodiment the amount of water was approximately at 40%. In the preferred embodiment Rhodoline 111 (obtained from Rhodia Novecare) was also added at 2% of the total weight of the binder and used as an anionic dispersant and also as a viscosity stabilizer for extended shelf life. Also included in the preferred embodiment was Rhodafac RE610, a phoshatized ethoxylated alkylphenol (a product of Rhone Poulenc) which is used as a surfactant at 1.5% of the total weight of the binder.

In the preferred embodiment a batch of the binder was prepared as follows. Twenty-eight pounds of the Van Gel B (1.0% by weight) was added to 1,109.9 pounds of water (39.6% by weight) and the mixture was blended for 45 minutes. To this solution was added 3.4 pounds of AF-10 (0.122% by weight), 42 pounds of RE-610 (1.5%), and 14 pounds of TRI6607 (0.5%) and 420 pounds of Michem 437 (15%) and the solution is then mixed for 20 minutes. Then 560.17 pounds of Styrofan NX 6650 (20%) and 420 pounds of Luster White FR2P (15%) was then mixed for an additional 20 minutes. Finally additional stabilizers were added including 2.8 pounds of Kelzan (0.1%), 137.24 pounds of propylene glycol (4.9%) and 56 pounds of Rhodoline 111 (2.0%) and 6.999 pounds of Proxel GXL (0.2499%) was added to the mixture.

The seed can be coated in a batch treatment process where in the seed is introduced to the batch treatment tank and one or more bioactive ingredients (such as Bayer's Poncho 600 in an undiluted solution, as well as other insecticides, fungicides and/or safener) are then added. To the seed coated with the bioactive ingredient is then added the liquid binder. A colorant can then be added to meet various regulatory requirements for signifying that the seed has been treated. Alternatively a continuous treatment process can be used to coat the seed wherein a water slurry is prepared containing one or more bioactive ingredients, the liquid coating, and, if needed, a colorant to color the seed. Then the seed is introduced into the slurry. In all cases the seed must be allowed a period of time to dry. Typically the seed is spun in a bowl for a period of at least 15 seconds to allow for drying. Different time periods may be needed to allow for variability in drying conditions due to weather or different seed sizes.

What is claimed is:

1. A seed coating comprising:
a. a binder;
b. a wax;
c. a pigment; and
d. one or more stabilizers in an amount effective to stabilize the suspension.

2. The coating of claim 1 wherein the binder is selected from the group consisting of polymers and co-polymers of a polyolefin.

3. The coating of claim 1 wherein the binder is a polymer selected from the group consisting of vinyl acetate-ethylene copolymer, vinyl acetate homopolymer, vinyl acetate-acrylic copolymer, vinylacrylic, acrylic, ethylene-vinyl chloride, vinyl ether maleic anhydride, or butadiene styrene.

4. The coating of claim 1 wherein the binder is a carboxylated styrene-butadiene dispersion.

5. The coating of claim 4 wherein the carboxylated styrene-butadiene dispersion is approximately 20% of the weight of the liquid coating.

6. The coating of claim 1 wherein the wax is selected from the group consisting of natural wax, vegetable wax, mineral wax, synthetic wax or other lubricant.

7. The coating of claim 6 wherein the natural wax is selected from the group consisting of beeswax or lanolin.

8. The coating of claim 6 wherein the mineral wax is selected from the group consisting of montan or paraffin.

9. The coating of claim 6 wherein the vegetable wax is carnauba.

10. The coating of claim 6 wherein the synthetic wax is selected from the group consisting of polyethylene (polar), polyethylene (nonpolar), polypropylene, Fischer-Tropsch or polybutene.

11. The coating of claim 6 wherein the other lubricant is polytetrafluoroethylene.

12. The coating of claim 1 wherein the wax is a micronized polyethylene wax.

13. The coating of claim 12 wherein the wax is in the range of from 10 to 30% of the weight of the liquid coating, preferably 15%.

14. The coating of claim 1 wherein the pigment is a pigment coated mica.

15. The coating of claim 1 wherein the pigment is a titanium dioxide coated mica.

16. The coating of claim 15 wherein the titanium dioxide coated mica is in the range of 0 to 15% of the weight of the liquid coating, preferably 15%.

17. The coating of claim 1 wherein the stabilizers are selected from the group consisting of a suspending aid and a humectant.

18. The coating of claim 1 wherein the stabilizers are selected from the group consisting of a suspending aid, a humectant and a biocide.

19. The coating of claim 17 wherein the suspending aid is selected from the group consisting of attapulgite clay, bentonite clay, smectite clay, hectorite clay, cellulosic, xanthum gum, or guar gum.

20. The coating of claim 18 wherein the biocide is 1,2-benzisothiazolin-3-one.

21. The coating of claim 20 wherein the biocide is in the range of 0.10 to 0.20% of the weight of the liquid coating, preferably 0.20%.

22. The coating of claim 17 wherein the humectant is propylene glycol.

23. The coating of claim 22 wherein the propylene glycol is in the range of 2.4 to 4.9% by weight of the liquid coating, preferably 4.9%.

24. The coating of claim 1 wherein the seed is selected from the group consisting of corn, wheat, soybean, canola, sunflower, alfalfa, edible beans, grain sorghum, turf and forage grass, and peas.

25. The coating of claim 1 wherein the seed is corn.

26. A process for coating a seed with a bioactive ingredient comprising the steps of:
a. Introducing the seed into a batch treatment system;
b. Applying one or more bioactive ingredients to the seed in the batch treatment system; and
c. Applying onto the seed coated with the bioactive ingredient a liquid coating comprised of a binder, a wax, and a pigment, and one or more stabilizers.

27. The process of claim 26 including a step of coloring the seed.

28. The process of claim 26 wherein there is a drying period of from 1 to 60 seconds between each step.

29. The process of claim 26 wherein the bioactive ingredient is selected from the group consisting of one or more of a fungicide, insecticide or safener.

30. The process of claim 29 wherein the insecticide is clothianidin.

31. The process of claim 26 wherein the binder is a polymer selected from the group consisting of vinyl acetate-ethylene copolymer, vinyl acetate homopolymer, vinyl acetate-acrylic copolymer, vinylacrylic, acrylic, ethylene-vinyl chloride, vinyl ether maleic anhydride, or butadiene styrene.

32. The process of claim 26 wherein the binder is a carboxylated styrene-butadiene dispersion.

33. The process of claim 32 wherein the carboxylated styrene-butadiene dispersion is approximately 20% of the weight of the liquid coating.

34. The process of claim 26 wherein the wax is selected from the group consisting of natural wax, vegetable wax, mineral wax, synthetic wax, or other lubricant.

35. The process of claim 34 wherein the natural wax is selected from the group consisting of beeswax or lanolin.

36. The process of claim 34 wherein the vegetable wax is carnauba.

37. The process of claim 34 wherein the mineral wax is montan or paraffin.

38. The process of claim 34 wherein the synthetic wax is polyethylene (polar), polyethylene (nonpolar), polypropylene, Fischer-Tropsch, or polybutene.

39. The process of claim 34 wherein the other lubricant is polytetrafluoroethylene.

40. The process of claim 34 wherein the wax is a micronized polyethylene wax in the range of from 10 to 30% of the weight of the liquid coating, preferably 15%.

41. The process of claim 26 wherein the pigment is a pigment coated mica.

42. The process of claim 41 wherein the pigment is titanium dioxide coated mica in the range of from 0 to 15% by weight of the liquid coating.

43. The coating of claim 26 wherein the stabilizers are selected from the group consisting of a suspending aid and a humectant.

44. The process of claim 26 wherein the stabilizers are selected from the group consisting of a suspending aid, a humectant and a biocide.

45. The process of claim 43 wherein the suspending aid is selected from the group consisting of attapulgite clay, bentonite clay, smectite clay, hectorite clay, cellulosic, xanthum gum, or guar gum.

46. The process of claim 44 wherein the biocide is 1,2-benzisothiazolin-3-one.

47. The process of claim 46 wherein the biocide is in the range of 0.10 to 0.20% of the weight of the liquid coating, preferably 0.20%.

48. The process of claim 43 wherein the humectant is propylene glycol.

49. The process of claim 48 wherein the propylene glycol is in the range of 2.4 to 4.9% by weight of the liquid coating, preferably 4.9%.

50. The process of claim 26 wherein the seed is selected from the group consisting of corn, wheat, soybean, canola, sunflower, alfalfa, edible beans, grain sorghum, turf and forage grass, and peas.

51. The process of claim 26 wherein the seed is corn.

52. A continuous process for coating a seed with a bioactive ingredient comprising the steps:
a. Blending in a water slurry comprising
i. one or more bioactive ingredients;
ii. colorant; and
iii. a liquid coating comprised of a wax, a binder, and pigment with one or more stabilizers; and
b. Introducing the seed into the water slurry.

53. The process of claim 52 wherein the bioactive ingredient is selected from the group consisting of one or more of a fungicide, insecticide or safener.

54. The process of claim 53 wherein the insecticide is clothianidin.

55. The process of claim 52 wherein the binder is a polymer selected from the group consisting of vinyl acetate-ethylene copolymer, vinyl acetate homopolymer, vinyl acetate-acrylic copolymer, vinylacrylic, acrylic, ethylene-vinyl chloride, vinyl ether maleic anhydride, or butadiene styrene.

56. The process of claim 52 wherein the binder is a carboxylated styrene-butadiene dispersion.

57. The process of claim 56 wherein the carboxylated styrene-butadiene dispersion is approximately 20% of the weight of the liquid coating.

58. The process of claim 52 wherein the wax is selected from the group consisting of natural wax, vegetable wax, mineral wax, synthetic wax, or other lubricant.

59. The process of claim 58 wherein the natural wax is selected from the group consisting of beeswax or lanolin.

60. The process of claim 58 wherein the vegetable wax is carnauba.

61. The process of claim 58 wherein the mineral wax is montan or paraffin.

62. The process of claim 58 wherein the synthetic wax is polyethylene (polar), polyethylene (nonpolar), polypropylene, Fischer-Tropsch, or polybutene.

63. The process of claim 58 wherein the other lubricant is polytetrafluoroethylene.

64. The process of claim 52 wherein the wax is a micronized polyethylene wax in the range of from 10 to 30% of the weight of the liquid coating, preferably 15%.

65. The process of claim 52 wherein the pigment is a pigment coated mica.

66. The process of claim 65 wherein the pigment is titanium dioxide coated mica in the range of from 0 to 15% by weight of the liquid coating.

67. The process of claim 52 wherein the stabilizers are selected from the group consisting of a suspending aid and a humectant.

68. The process of claim 52 wherein the stabilizers are selected from the group consisting of a suspending aid, a humectant and a biocide.

69. The process of claim 67 wherein the suspending aid is selected from the group consisting of attapulgite clay, bentonite clay, smectite clay, hectorite clay, cellulosic, xanthum gum, or guar gum.

70. The process of claim 68 wherein the biocide is 1,2-benzisothiazolin-3-one.

71. The process of claim 70 wherein the biocide is in the range of 0.10 to 0.20% of the weight of the liquid coating, preferably 0.20%.

72. The process of claim 67 wherein the humectant is propylene glycol.

73. The process of claim 72 wherein the propylene glycol is in the range of 2.4 to 4.9% by weight of the liquid coating, preferably 4.9%.

74. The process of claim 52 wherein the seed is selected from the group consisting of corn, wheat, soybean, canola, sunflower, alfalfa, edible beans, grain sorghum, turf and forage grass, and peas.

75. The process of claim 52 wherein the seed is corn.

76. A product of coating a seed by the process comprising the steps:
a. Blending in a water slurry comprising
i. one or more bioactive ingredients;
ii. colorant; and
iii. a liquid coating comprised of a wax, a binder, and pigment with one or more stabilizers; and
b. Introducing the seed into the water slurry.

77. A product of coating a seed by the process comprising the steps of
a. Introducing the seed into a batch treatment system;
b. Applying one or more bioactive ingredients to the seed in the batch treatment system; and
c. Applying onto the seed coated with the bioactive ingredient a liquid coating comprised of a binder, a wax, and a pigment, and one or more stabilizers.
